(19) United States
(12) Patent Application Publication
(10) Pub. No.: US 2014/0070047 A1
(43) Pub. Date: Mar. 13, 2014

(54) Multifunctional Structural Power and Lighting System

(71) Applicant: Bell Helicopter Textron Inc., (US)

(72) Inventors: Randy B. Williams, Arlington, TX (US); Charles DeJean, Fort Worth, TX (US); Geoffrey Latham, Dallas, TX (US); David Sparks, Fort Worth, TX (US); Angelo Yializis, Tuscon, AZ (US)

(73) Assignee: Bell Helicopter Textron Inc., Fort Worth, TX (US)

(21) Appl. No.: 13/856,195

(22) Filed: Apr. 3, 2013

Related U.S. Application Data
(60) Provisional application No. 61/623,740, filed on Apr. 13, 2012.
(60) Provisional application No. 61/783,902, filed on Mar. 14, 2013.

(51) Int. Cl. H05B 33/06; B64D 47/02; B64C 27/06

(52) U.S. Cl. CPC H05B 33/06; B64C 27/06; B64D 47/02
USPC 244/17.11; 315/312

(57) ABSTRACT

According to one embodiment, a structural electrical system includes an electrical power source operable to provide electrical current, a structural composite, and a plurality of output devices. The structural composite includes alternating layers of conductive layers and insulative layers. Each conductive layer is less than or equal to 500 nanometers thick and each conductive layer is in electrical communication with the electrical power source. The plurality of output devices are in electrical communication with each conductive layer and are operable to receive electrical current from the electrical power source through the conductive layers.

### RELATED APPLICATIONS

Pursuant to 35 U.S.C. §119 (e), this application claims priority to United States Provisional Patent Application Ser. No. 61/783,902, entitled MULTIFUNCTIONAL STRUCTURAL POWER AND LIGHTING SYSTEM, filed Mar. 14, 2013. U.S. Provisional Patent Application Ser. No. 61/783,902 is hereby incorporated by reference.

Pursuant to 35 U.S.C. §119 (e), this application claims priority to U.S. Provisional Patent Application Ser. No. 61/623,740, entitled MULTIFUNCTIONAL STRUCTURAL LIGHTING SYSTEM, filed Apr. 13, 2012. U.S. Provisional Patent Application Ser. No. 61/623,740 is hereby incorporated by reference.

### TECHNICAL FIELD

This invention relates generally to composite materials, and more particularly, to a multifunctional structural power and lighting system.

### BACKGROUND

A rotorcraft may include one or more rotor systems. One example of a rotorcraft rotor system is a main rotor system. A main rotor system may generate aerodynamic lift to support the weight of the rotorcraft in flight and thrust to counteract aerodynamic drag and move the rotorcraft in forward flight. Another example of a rotorcraft rotor system is a tail rotor system. A tail rotor system may generate thrust in the same direction as the main rotor system's rotation to counter the torque effect created by the main rotor system.

### SUMMARY

Particular embodiments of the present disclosure may provide one or more technical advantages. A technical advantage of one embodiment may include the capability to provide electrical power to lighting and other devices. A technical advantage of one embodiment may also include the capability to eliminate undesirable weight from a vehicle by replacing some conventional wiring harnesses. A technical advantage of one embodiment may also include the capability to provide redundant electrical power such that the lighting or other electrical device is not subject to a single point of failure.

Certain embodiments of the present disclosure may include some, all, or none of the above advantages. One or more other technical advantages may be readily apparent to those skilled in the art from the figures, descriptions, and claims included herein.

### BRIEF DESCRIPTION OF THE DRAWINGS

To provide a more complete understanding of the present invention and the features and advantages thereof, reference is made to the following description taken in conjunction with the accompanying drawings, in which:

FIG. 1 shows a rotorcraft according to one example embodiment;

FIG. 2 shows a structural power system according to one embodiment;

FIGS. 3A and 3B show an example lighting system based on the structural power system of FIG. 2;

FIG. 4 shows another example lighting system based on the structural power system of FIG. 2; and

FIG. 5 shows the lighting system of FIG. 3A installed on the rotorcraft of FIG. 1.

### DETAILED DESCRIPTION OF THE DRAWINGS

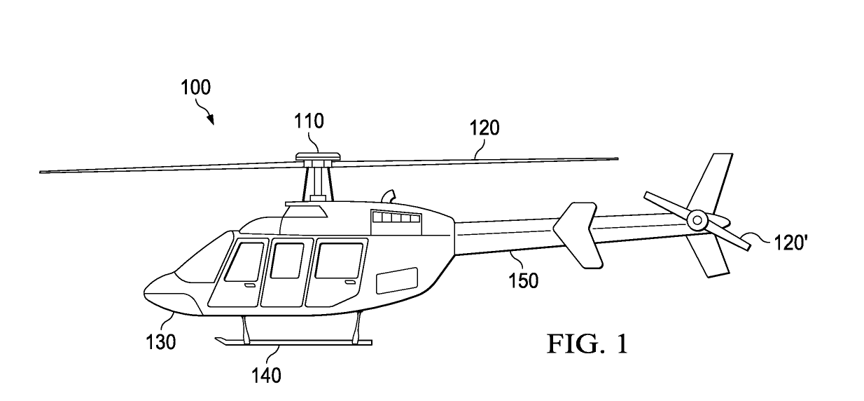

FIG. 1 shows a rotorcraft 100 according to one example embodiment. Rotorcraft 100 features a rotor system 110, blades 120, a fuselage 130, a landing gear 140, and an empennage 150. Rotor system 110 may rotate blades 120. Rotor system 110 may include a control system for selectively controlling the pitch of each blade 120 in order to selectively control direction, thrust, and lift of rotorcraft 100. Fuselage 130 represents the body of rotorcraft 100 and may be coupled to rotor system 110 such that rotor system 110 and blades 120 may move fuselage 130 through the air. Landing gear 140 supports rotorcraft 100 when rotorcraft 100 is landing and/or when rotorcraft 100 is at rest on the ground. Empennage 150 represents the tail section of the aircraft and features components of a rotor system 110 and blades 120′. Blades 120′ may provide thrust in the same direction as the rotation of blades 120 so as to counter the torque effect created by rotor system 110 and blades 120. Teachings of certain embodiments relating to rotor systems described herein may apply to rotor system 110 and/or other rotor systems, such as other tilt rotor and helicopter rotor systems. It should also be appreciated that teachings regarding rotorcraft 100 may apply to aircraft and vehicles other than rotorcraft, such as airplanes and unmanned aircraft, to name a few examples.

Rotorcraft 100 represents one example of a vehicle that includes a variety of different electrical devices. Conventional internal and external electrical devices are typically provided with power by wiring harnesses in accordance with traditional circuit designs. However, conventional wiring harnesses are singular in function and add undesirable weight to the vehicle. For example, clamps, fasteners, cable ties, and other items that may be required for installation of a conventional wiring harness, add undesirable weight and consume valuable space in the vehicle. Further, the wiring itself can be an undesirable single point of failure; for example, battle damage from a projectile can sever the wiring, thus breaking the circuit and rendering the electrical device inoperable. Further, conventional electrical devices can generate heat that may require dissipation through a thermal conductor or heat sink, which can further result in undesired weight.

Accordingly, teachings of certain embodiments recognize the capability to provide a structural power system that may eliminate the need for some conventional wiring harnesses. Teachings of certain embodiments recognize that the structural power system may be integrated with structural components of rotorcraft 100, such as a structural aircraft panel.

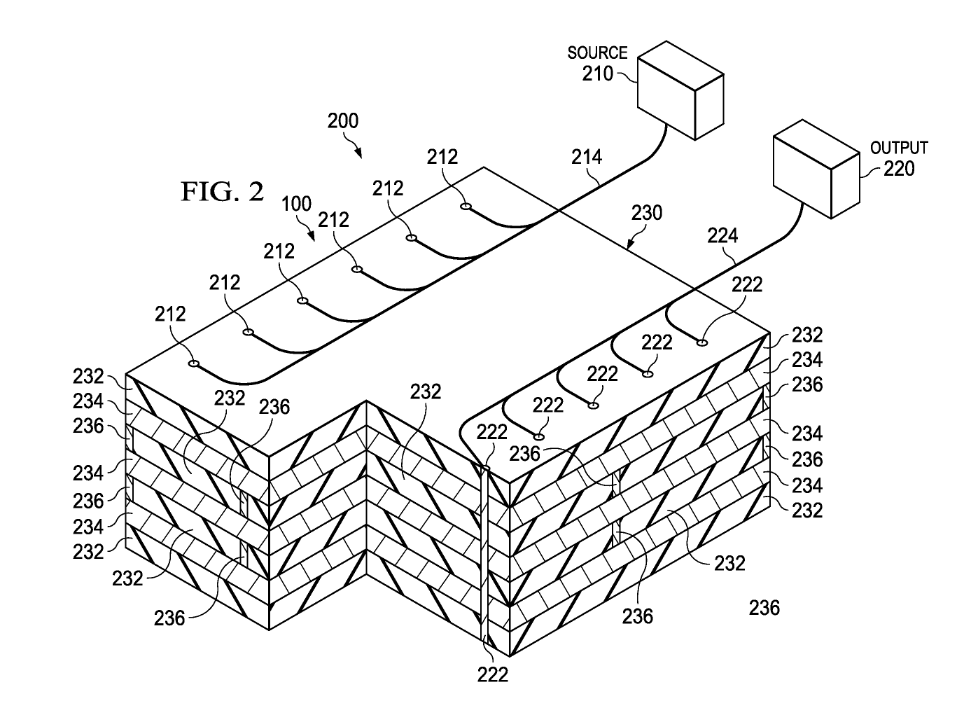

FIG. 2 shows a structural power system 200 according to one embodiment. Elements of structural power system 200 are not drawn to scale. In the example of FIG. 2, structural power system 200 features an electrical source 210, an electrical output 220, and a structural composite 230. Structural composite 230 features alternating layers of insulative layers 232 and conductive layers 234. In one example embodiment, insulative layers 232 may represent vacuum-deposited, radiation-cured polymer dielectric layers separating metal electrode conductive layers 234. In some embodiments, insulative layers 232 may be of the type that adheres to aluminum or other metals.

Teachings of certain embodiments recognize that structural composite 230 may conduct electricity through the in-plane conductive layers 234 while retaining insulative properties in the perpendicular direction. In addition, teachings of certain embodiments recognize that structural composite 230 may conduct heat through the in-plane conductive layers 234 while retaining insulative properties in the perpendicular direction.

Conductive members 236 extend through at least some of the insulative layers 232 to provide an electrical and/or thermal connection between adjacent conductive layers 234. In some embodiments, conductive members 236 may be provided at the exterior edges of structural composite 230 and/or in interior portions of structural composite 230. Teachings of certain embodiments recognize that conductive members 236 may short together multiple conductive layers 234 so as to provide redundant conductive paths. For example, sample structural composites 230 were subject to ballistic testing with a 7.62×39 mm ball-type (aligned) round, a 0.50 cal AP (aligned) round, and a 0.50 cal AP (tumbled) round. In this ballistic testing, the structural composite 230 did not suffer from degradation in electrical behavior due to the ballistic damage (other than loss of insulation material in the area immediately surrounding the projectile impacts).

In one example embodiment, conductive members 236 are formed by first plasma etching away a selective amount of insulative layers 232 near the edges and then spraying a zinc-tin alloy to short the conductive layers 234. Teachings of certain embodiments recognize, however, that conductive layers 234 may be electrically and/or thermally coupled in a variety of ways. Furthermore, as will be explained in greater detail below, selective conductive layers 234 may remain separated in various combinations to enable multiple conductive paths to multiple electrical devices.

In the example of FIG. 2, the insulative layers 232 and conductive layers 234 of structural composite 230 may be bonded together using any suitable technique. In addition, insulative layers 232 and conductive layers 234 may be made from any suitable material. In one example embodiment, insulative layers 232 are made from an insulative polymer, and conductive layers 234 are made from aluminum (such as pure aluminum). In some embodiments, conductive layers 234 are made from other materials, such as an aluminum alloy, zinc, a zinc alloy, copper, or a copper alloy.

In some embodiments, insulative layers 232 and/or conductive layers 234 are nanoscale thickness. For example, in some embodiments, conductive layers 234 are less than 500 nanometers thick. In particular embodiments, conductive layers 234 are 150 nanometers thick. In two example configurations, conductive layers 234 are 150 nanometers thick, and insulative layers 232 are 0.8 millimeters or 0.6 millimeters thick. In these example configurations, structural composite 230 may transmit a current of approximately 50 amps in some settings. In another example configuration, structural composite 230 may transmit a current of approximately 25 amps if the insulative layers 232 are 0.5 millimeters thick and the conductive layers 234 are approximately 75 nanometers thick.

In some embodiments, structural composite 230 may exhibit structural properties. For example, in some embodiments, structural composite 230 may exhibit tensile strengths up to 50% greater than that for a pure aluminum panel of the same thickness while at a density that is approximately 18% lighter. If desired, additional insulation protection beyond insulative layers 232 may be provided in a variety ways, such as overcoating, wrapping, or bonding electrically insulative structural or non-structural materials or coatings, e.g. fiberglass/epoxy.

Electrical source 210 is electrically coupled to structural composite 230 via connectors 212 and transmission lines 214. Connectors 212 extend at least partially though structural composite 230 and are in electrical communication with at least some conductive layers 234. Transmission lines 214 provide electrical communication between electrical source 210 and connectors 212.

Electrical output 220 is electrically coupled to structural composite 230 via connectors 222 and transmission lines 224. Connectors 222 extend at least partially though structural composite 230 and are in electrical communication with at least some conductive layers 234. Transmission lines 224 provide electrical communication between electrical output 220 and connectors 222.

Connectors 212 and 222 may be of any suitable shape. In some embodiments, connectors 212 and 222 may be shaped so as to provide sufficient electrical contact to conductive layers 234. In addition, connectors 212 and 222 may be shaped such that they are retained by structural composite 230. In one example embodiment, connectors 212 and 222 may be threadably engaged to insulative layers 232 and/or conductive layers 234. In another example embodiment, connectors 212 and 222 are substantially cylindrical and are disposed within holes in insulative layers 232 and/or conductive layers 234. In yet another example embodiment, connectors 212 and 222 are extended shafts having a plurality of sides (e.g., a five-sided star, a sixteen-sided star, etc.) and may be disposed within holes in insulative layers 232 and/or conductive layers 234 having corresponding shapes. Teachings of certain embodiments recognize that additional surfaces and/or surface area may provide for a stronger contact connection between connectors 212 and 222 and conductive layers 234.

Connectors 212 and 222 may be inserted into structural composite 230 in any suitable manner. In one example, a hole is drilled in structural composite 230. Next, the hole is rinsed in alcohol, and the polymer in the hole is plasma-ashed to reveal more conductive material. The hole is then cleaned with compressed air, and conductive silver nanoflakes are provided in the hole to increase conductivity between connectors 212 and 222 and conductive layers 234. Connectors 212 and 222 are then press-fit in each hole of structural composite 230.

In operation, according to one example embodiment, electrical source 210 provides electrical current through transmission lines 214 and connectors 212 to conductive layers 234. Connectors 222 receive electrical current from conductive layers 234 and transmit the electrical current through transmission lines 224 to electrical output 220.

Teachings of certain embodiments recognize that such a configuration may eliminate a portion of traditional wiring between electrical source 210 and electrical output 220 by incorporating this function into the structure, thereby saving weight associated with conventional wiring, while forming redundant current paths, and reducing costs associated with installation and maintenance of conventional wiring. Further, the reliability and maintainability of the power carrying members are improved because they are embedded in the structure and therefore less susceptible to damage. Further, volume that would otherwise be occupied by conventional wiring harnesses can be utilized for other uses. Further, structural power system 200 is less vulnerable to ballistic damage since conductive layers 234 can continue to conduct electrical power or current even after penetration by a projectile.

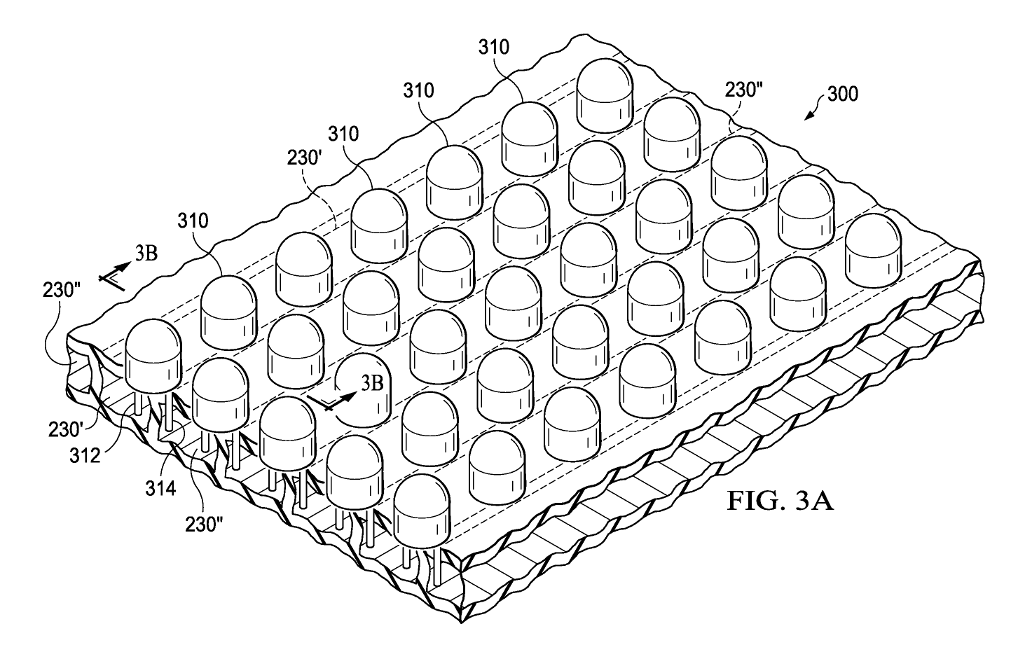

The structural power system 200 of FIG. 2 may power a variety of electrical devices. FIG. 3A shows a perspective view of an example lighting system 300, and FIG. 3B shows a cross-section of lighting system 300. Lighting system 300 shows an example of a structural composite 230 providing electrical current to light-emitting diodes (LEDs).

In the lighting system 300a of FIG. 3A, electrical current is provided to LEDs 310 through leads 312 and 314. In this example, lead 312 is a positive lead, and lead 314 is a negative lead. A multi-bus panel includes structural composites sections 230′ and 230″. Structural composite sections 230′ and 230″ are arranged in alternating strips. In the example of FIG. 3A, the positive lead 312 of each LED is in contact with a composite section 230′, and the negative lead 314 of each LED is in contact with a composite section 230″. As seen in FIG. 3B, insulative material 320 separates positive composite sections 230′ from negative composite strips 230″.

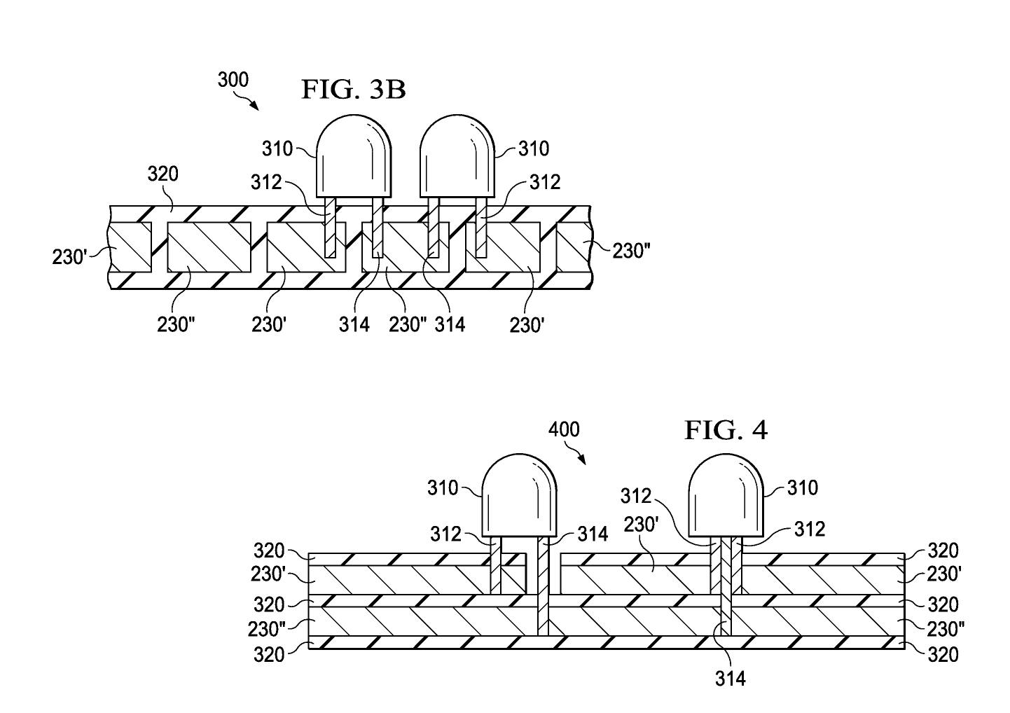

FIG. 4 shows a lighting system 400 according to another example embodiment. Example lighting system 400 also includes positive composite sections 230′ and negative composite sections 230″ separated by insulative material 320. In the example of FIG. 4, however, composite sections 230′ and 230″ are not divided into strips. Rather, composite sections 230′ and 230″ are stacked: a positive composite section 230′ resides on top of a negative composite section 230″ and separated by insulative material 320.

The example of FIG. 4 shows two configurations for providing electrical contact between a LED 310 and composite sections 230′ and 230″. In the left-hand example, lead 312 contacts composite section 230′, and lead 314, which is longer than lead 312, extends through an opening in composite section 230′ to contact composite section 230″. In the right-hand example, a shorter lead 312 surrounds a longer lead 314. In this example, leads 312 and 314 are inserted into a common opening in composite section 230′; lead 312 contacts the surrounding surfaces of composite section 230′, and lead 314 extends into composite section 230″.

Lighting systems 300 and 400 represent just two example configurations for providing electrical current to LEDs through structural composite 230. Teachings of certain embodiments recognize that other arrangements may be provided.

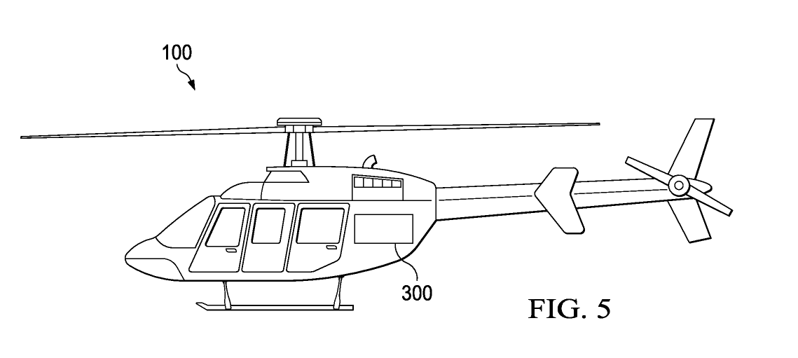

FIG. 5 shows lighting system 300 of FIG. 3A installed on an exterior surface of rotorcraft 100. In this example, lighting system 300 provides exterior light during operations of rotorcraft 100. Although lighting system 300 is shown in FIG. 5, teachings of certain embodiments recognize that lighting system 400 or another lighting configuration may also provide exterior light for rotorcraft 100.

It should be appreciated that even though lighting system 300 is illustrated as providing exterior lighting, structural lighting system 300 can be implemented for internal lighting as well. Further, it should be appreciated that lighting system 300 can be configured in a wide variety of shapes, sizes, and contours. The lights of structural lighting system 300 can be configured to display and/or communicate a wide variety of lighting features. Exemplary lighting embodiments can be configured for display of requisite exterior aircraft lighting, to identify the aircraft as a certain emergency aircraft, for display of police lighting, or to communicate interior passenger egress, to name a few examples.

Modifications, additions, or omissions may be made to the systems and apparatuses described herein without departing from the scope of the invention. The components of the systems and apparatuses may be integrated or separated. Moreover, the operations of the systems and apparatuses may be performed by more, fewer, or other components. The methods may include more, fewer, or other steps. Additionally, steps may be performed in any suitable order.

Although several embodiments have been illustrated and described in detail, it will be recognized that substitutions and alterations are possible without departing from the spirit and scope of the present invention, as defined by the appended claims.

To aid the Patent Office, and any readers of any patent issued on this application in interpreting the claims appended hereto, applicants wish to note that they do not intend any of the appended claims to invoke paragraph 6 of 35 U.S.C. §112 as it exists on the date of filing hereof unless the words “means for” or “step for” are explicitly used in the particular claim.

What is claimed is:

1. A rotorcraft, comprising:
a body;
a power train coupled to the body and comprising a power source and a drive shaft coupled to the power source;
a hub;
a rotor blade coupled to the hub;
an electrical power source operable to provide electrical current;
a structural composite coupled to the body, the structural composite comprising alternating layers of conductive layers and insulative layers, wherein each conductive layer is less than or equal to 500 nanometers thick and each conductive layer is in electrical communication with the electrical power source; and
a plurality of light-emitting diodes (LEDs) in electrical communication with each conductive layer and operable to receive electrical current from the electrical power source through the conductive layers.

2. The rotorcraft of claim 1, wherein the structural lighting system is coupled to an exterior surface of the body such that the light-emitting diodes emit light outside the rotorcraft.

3. The rotorcraft of claim 1, wherein the alternating layers of conductive layers and insulative layers comprise a plurality of interleaved, vacuum-deposited, metal electrode layers, each electrode layer separated by vacuum-deposited, radiation-cured polymer dielectric layers.

4. The rotorcraft of claim 1, wherein each conductive layer is aluminum, aluminum alloy, zinc, copper, or copper alloy.

5. The rotorcraft of claim 4, wherein the structural composite has a tensile strength greater than pure aluminum.

6. The rotorcraft of claim 4, wherein the structural composite has a density lighter than pure aluminum.

7. The rotorcraft of claim 1, wherein the plurality of LEDs are coupled to an exterior surface of the structural composite.

8. The rotorcraft of claim 1, wherein the conductive layers provide redundant electrical paths between the electrical power source and the plurality of LEDs.

9. The rotorcraft of claim 1, further comprising:
a second electrical power source operable to provide electrical current;
a second structural composite coupled to the structural composite, the second structural composite comprising alternating layers of conductive layers and insulative layers, wherein each layer is less than or equal to 100 nanometers thick and each conductive layer is in electrical communication with the second electrical power source; and
a second plurality of LEDs in electrical communication with each conductive layer of the second structural composite and operable to receive electrical current from the second electrical power source through the conductive layers of the second structural composite.

10. The rotorcraft of claim 9, further comprising:
a first plurality of connectors disposed through and in physical contact with the alternating layers of conductive layers and insulative layers of the structural composite and in electrical communication with the plurality of LEDs; and
a second plurality of connectors disposed through and in physical contact with the alternating layers of conductive layers and insulative layers of the second structural composite and in electrical communication with the second plurality of LEDs.

11. A structural electrical system, comprising:
an electrical power source operable to provide electrical current;
a structural composite comprising alternating layers of conductive layers and insulative layers, wherein each conductive layer is less than or equal to 500 nanometers thick and each conductive layer is in electrical communication with the electrical power source; and
a plurality of output devices in electrical communication with each conductive layer and operable to receive electrical current from the electrical power source through the conductive layers.

12. The system of claim 11, wherein the output devices are light-emitting diodes (LEDs).

13. The system of claim 11, wherein the alternating layers of conductive layers and insulative layers comprise a plurality of interleaved, vacuum-deposited, metal electrode layers, each electrode layer separated by vacuum-deposited, radiation-cured polymer dielectric layers.

14. The system of claim 11, wherein each conductive layer is aluminum, aluminum alloy, zinc, copper, or copper alloy.

15. The system of claim 14, wherein the structural composite has a tensile strength greater than pure aluminum.

16. The system of claim 14, wherein the structural composite has a density lighter than pure aluminum.

17. The system of claim 11, wherein the plurality of output devices are coupled to an exterior surface of the structural composite.

18. The system of claim 11, wherein the conductive layers provide redundant electrical paths between the electrical power source and the plurality of output devices.

19. The system of claim 11, further comprising:
a second electrical power source operable to provide electrical current;
a second structural composite coupled to the structural composite, the second structural composite comprising alternating layers of conductive layers and insulative layers, wherein each layer is less than or equal to 100 nanometers thick and each conductive layer is in electrical communication with the second electrical power source; and
a second plurality of output devices in electrical communication with each conductive layer of the second structural composite and operable to receive electrical current from the second electrical power source through the conductive layers of the second structural composite.

20. The system of claim 19, further comprising:
a first plurality of connectors disposed through and in physical contact with the alternating layers of conductive layers and insulative layers of the structural composite and in electrical communication with the plurality of output devices; and
a second plurality of connectors disposed through and in physical contact with the alternating layers of conductive layers and insulative layers of the second structural composite and in electrical communication with the second plurality of output devices.
